(19) United States
(12) Patent Application Publication
(10) Pub. No.: US 2008/0236126 A1
(43) Pub. Date: Oct. 2, 2008

(54) Destemming Device and Method for Harvesting Machines

(75) Inventor: Luciano Leonini, Monteroni D'Arbia(SI) (IT)

Correspondence Address: EGBERT LAW OFFICES, 412 MAIN STREET, 7TH FLOOR, HOUSTON, TX, 77002, US

(73) Assignee: Volentieri-Pellenc (Societe de droit Italien), Barberino (IT)

(21) Appl. No.: 10/577,708

(22) PCT Filed: Nov. 10, 2004
(86) PCT No.: PCT/EP2004/014156

§ 371 Date: Jun. 17, 2008

(30) Foreign Application Priority Data
Nov. 10, 2003 (FR) 0313190

(51) Int. Cl. A23N 15/02

(52) U.S. Cl. 56/330

(57) ABSTRACT

The destemming device is installed on a harvesting machine, between the sloping end of the harvesting conveyors and the harvest collection bowls pertaining to the machine. The destemming device includes, upstream in the direction of the supply of the rough harvest, an extractor system for extracting the juice and the grapes detached from the stems by the crop package; and, downstream, a stemmer provided with an inlet that communicates with the sloping end of the extractor system. The stemmer enables the hacking of the bunches forming the remaining part of the harvest, and the rejection of the stems, plant waste and other undesirable products.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention relates to a destemming device and method applicable to harvesting machines, said device and method making it also possible to remove various waste contained in the harvest collected through the collection belts and conveyors of said machines.

### BACKGROUND OF THE INVENTION

Although it is an optional operation, the destemming that consists of separating the grapes from the branchy stems that form the peduncle and pedicels of the bunch, is very widely used in many regions before crushing the grapes. The presence of the stem and especially of the bunch tailpiece in the fermentation and maceration tanks indeed produces coarse tannins that obliterate the fineness and fruity nature and is the cause of the hardiness of certain wines. By eliminating the astringent, harsh and herbaceous stems, the gustatory qualities and fineness of future wine are improved.

In addition, grape mechanical harvesting using harvesting machines is today an unavoidable technological development because of the many advantages it offers and since this harvesting method is well controlled throughout the production line, it gives as good qualitative results as manual harvesting.

With machine harvesting, the fruit and all plant matters detached using the machine harvesting system fall onto collection belts and conveyors and are fed to stainless steel containers that are emptied at the end of the line into a transporting bowl. During transit up to the containers carried by the machine, part of the undesirable plant waste (leaves, wood particles, . . . ) is removed from the harvest with blowers or other devices installed on the path upstream of the containers.

However, the rough harvest emptied into the containers of the harvesting machines contains a significant percentage of grapes detached from the stems, a lesser percentage of grape juice and a certain quantity of green products (leaves with their petioles) and various undesirable wastes, such as vine shoots, stake debris, clips, insects, small animals, etc. The crop with the above composition is emptied into transporting bowls and then taken to the cellar for further sorting and picking-off.

If one wants to prevent starting maceration of the green products and oxidation of the crop likely to alter the gustatory qualities of the future wine, the delay between grape harvesting and hacking of the grape bunches must be very short; however, in many cases, this delay can be relatively long.

In order to reduce the time between harvesting and hacking, some constructors propose harvesting machines equipped with stemmers where the rough harvest is emptied by the collecting belts and harvest conveyors. However, all of the components of the rough harvest go through the stemmer, which seems to be a heresy if one considers that approx. 75% of the rough harvest emptied by the collecting belts and conveyors is made of juice and grapes detached from the stems. This situation causes several disadvantages, such as, for example:
large size of the stemmers that must be capable of processing all of the rough harvest so that these bulky apparatuses are difficult to load onto harvesting machines;
significant usage of energy because of the large volume of the rough harvest processed in the stemmer;
unnecessary crushing of all components of the rough harvest favoring extraction of the vacuolar sap from the tissue of the stem rich in bitter and astringent substances that may give a bad taste to the future wine and promote the mixing of this sap with the juice resulting from the bursting of the grapes already picked off;
incomplete destemming due to the significant quantity of already detached grapes introduced into the stemmer with non-hacked bunches, causing plugging and hindering the efficiency of the destemming action on said bunches; and
slow operation.

The goal of the destemming method and device under the invention includes eliminating these disadvantages.

### BRIEF SUMMARY OF THE INVENTION

Under the invention, this goal is achieved through a destemming method under which, when transferring the rough harvest between the sloping end of the harvesting conveyors and the harvest collection bowls, the following takes place in succession:
in a first step, extracting the juice and the grapes detached from the stems by the crop package; and
in a second step, picking off the grape bunches not already destemmed forming the remaining part of the rough harvest.

The destemming device under the invention comprises, upstream in the direction of the supply of the rough harvest, an extractor system for extracting the juice and the grapes detached from the stems. The extractor consists, for example, of a conveyor screen executed in the form of an endless belt provided with a mesh and holes sized so as let through only the juice and grapes forming part of the rough harvest and to retain the grapes not picked off, and downstream, a stemmer provided with an inlet that communicates with the sloping end of the extractor system, said stemmer enabling the hacking of the bunches forming the remaining part of the harvest and the rejection of the hacked stems and undesirable plant (leaves, twigs, etc.).

Through the implementation of the destemming device and method under the invention, the juice and grapes detached from the bunches are extracted by gravity when feeding the rough harvest to the harvest collection bowls so that the part thereof that is subject to hacking is only in the order of 20% to 25%. This situation presents several interesting advantages:
Ability to reduce the bulkiness of the stemmers, thus making it easier to load them onto the harvesting machines;
Reduced energy usage;
Crushing limited to the non-picked off bunches;
Cleaner and more thorough destemming;
Faster operation; and
Very significant reduction of the delays between the harvesting operations and the arrival in the cellar of the harvest stripped of its undesirable components and ready for the crushing operation.

A number of causes likely to alter the gustatory qualities of the wine are thus eliminated.

According to an advantageous embodiment, the stemmer of the stemming system or of each destemming system of the harvesting machine is oriented perpendicular to the extractor or sorter. More specifically, the extractor or each extractor is arranged parallel or longitudinally in relation to the moving direction of the machine when working, while the stemmer or each stemmer is arranged crosswise or perpendicular to said moving direction.

A significant advantage resulting from this characteristic arrangement is that the flow in the stemmer is not influenced by the various slopes of the terrain on which the machine may have to move during the harvesting so that the time for the harvest to go through the stemmer is constant whether going up or going down. In addition, waste of all kinds (petioles, vine shoots, stems, etc.) is ejected laterally.

### BRIEF DESCRIPTION OF THE SEVERAL VIEWS OF THE DRAWINGS

The above-mentioned goals, characteristics and advantages and others will become more evident from the description below and the attached drawings.

FIG. 1 is a side view of a first embodiment of the destemming device under the invention.

FIG. 2 is a top plan view of FIG. 1.

FIG. 3 is a sectional view along line 3-3 of FIG. 1.

FIG. 4 is a side view illustrating the operation of the destemming device installed in the upper part of a harvesting machine for which only the upper part is shown.

FIG. 5 is a top plan view of FIG. 4.

FIG. 6 is a rear view of FIG. 4.

FIG. 7 is a side view of a second preferred example of the destemming device under the invention.

FIG. 8 is a top plan view of FIG. 7, the rotating cage of the stemmer being shown only in a partial cross-section.

FIG. 9 is a rear view of the destemming device.

FIG. 10 is a side view illustrating the operation of this destemming device shown installed in the upper part of a harvesting machine for which only the upper part is represented.

FIG. 11 is a top plan view of FIG. 10.

FIG. 12 is a rear view of FIG. 10.

FIG. 13 is a side view illustrating the discharge of the destemmed harvest collected in the collection bowl or one of the collection bowls of the machine.

### DETAILED DESCRIPTION OF THE INVENTION

These drawings are also referred to describe interesting, but not limiting, examples of implementation of the method and execution of the destemming device under the invention.

A very interesting application of this destemming method and device equipping berry harvesting machines such as grape harvesting machines is described below, but it is pointed out that other applications of this method and device are possible.

Berry harvesting machines, such as grape harvesting machines, comprise most often a well-known crop package, supported by a straddling carrying structure (not illustrated), either self-propelled or designed to be able to be installed in a removable manner on a tractor. The crop package comprises a shaking device, consisting generally of two grape detaching systems 1 between which a space is provided to be able to go through the row of vine stocks or other shrubs lapped over. The grapes and bunches detached from the stocks are collected, on each side of the median vertical plane of the crop package on an articulated floor made of inclined and mobile overlapping plates or scales 2 that join together around the stocks. The rough crop is thus collected, being fed to harvest collection bowls 3 mounted in such manner that they can be tipped in the upper part of the machines, through harvest conveyor systems. Each conveyor system comprises, for example, a lower horizontal section (not represented) and an upward section 4 feeding the rough harvest to the upper part of the harvesting machine.

As indicated in the preamble to this disclosure, it is known to install a stemmer downstream of the sloping end of the upward section 4 of the harvesting conveyor systems.

According to the method under the invention, the following takes place in succession, when feeding the rough harvest V, between the sloping end of the harvest conveyors 4 and the harvest collection bowls 3:
in a first phase, extracting of the juice and the grapes B detached from the stems by the crop package, and,
in a second phase, destemming of the grape bunches G not already destemmed that form the remaining part of the rough harvest.

A destemming device under the invention is installed between each harvest conveyor system 4 and the harvest collection bowl 3 located on the same side.

Although in practice, it is planned to apply the invention device and method to grape harvesting machines comprising a harvest conveyor system and a crop collection bowl on each side of the median vertical plane of the crop package of said machines. It is not excluded to apply the invention to smaller and lighter harvesting machines comprising only one conveyor system and only one harvest collection bowl.

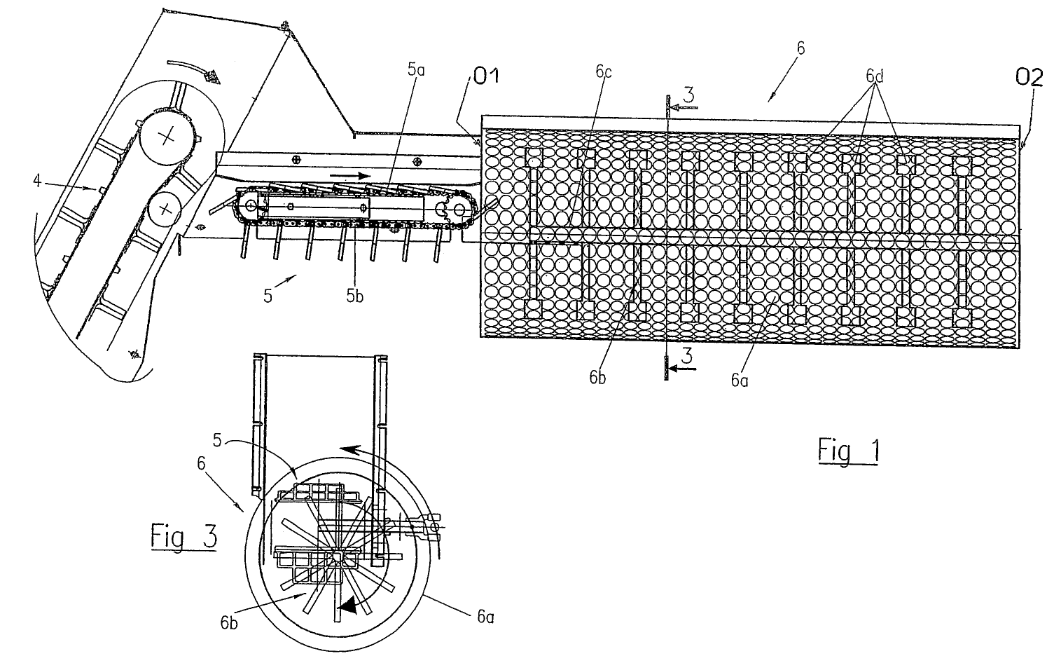

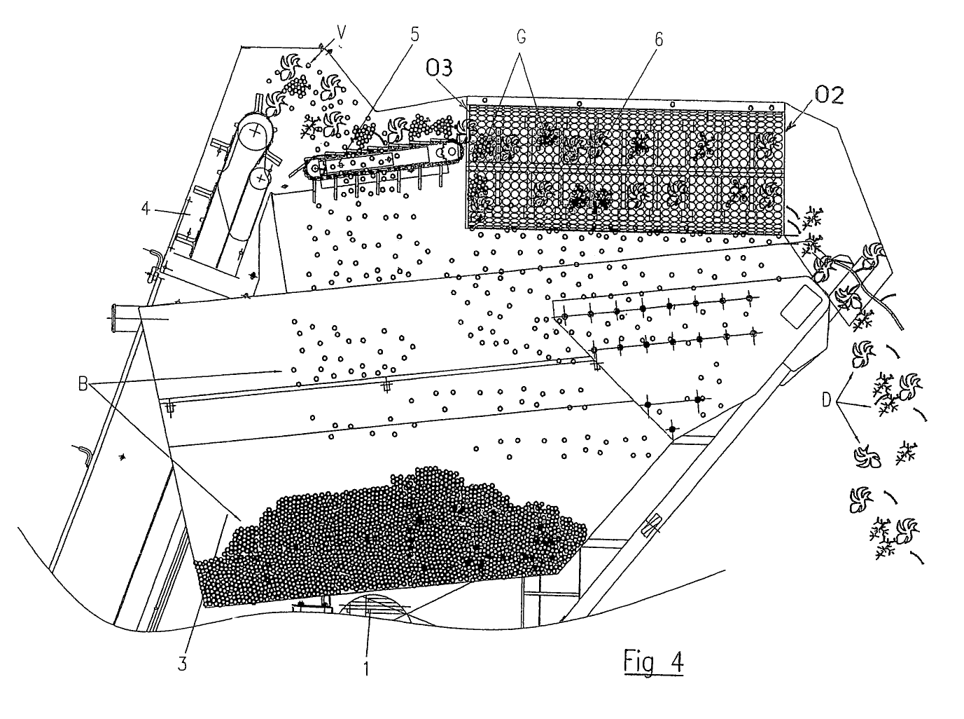

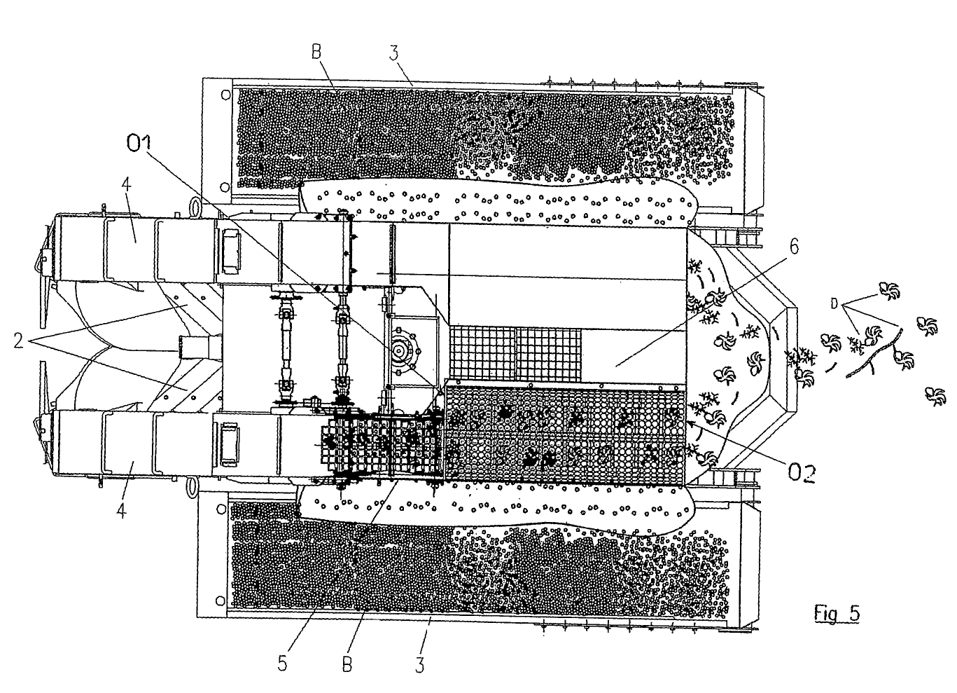

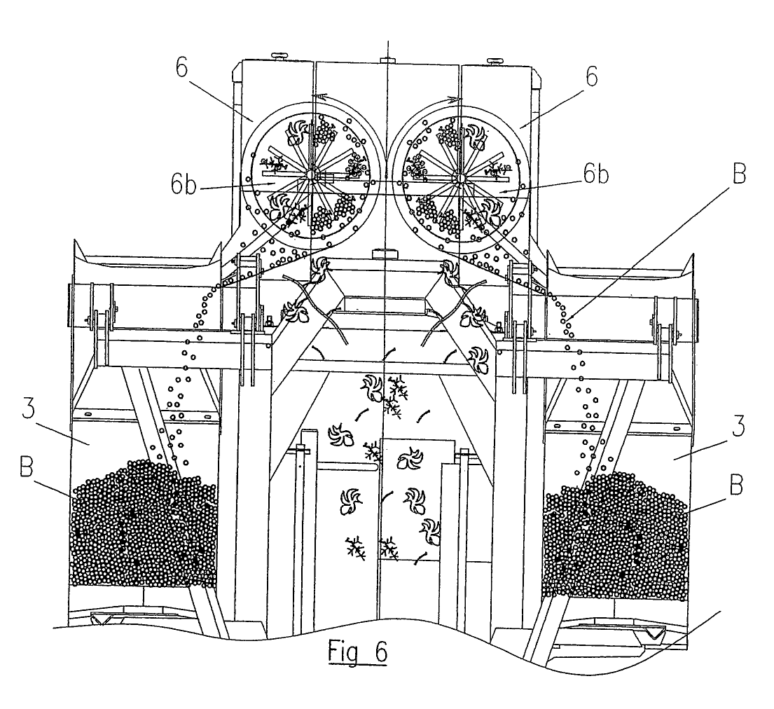

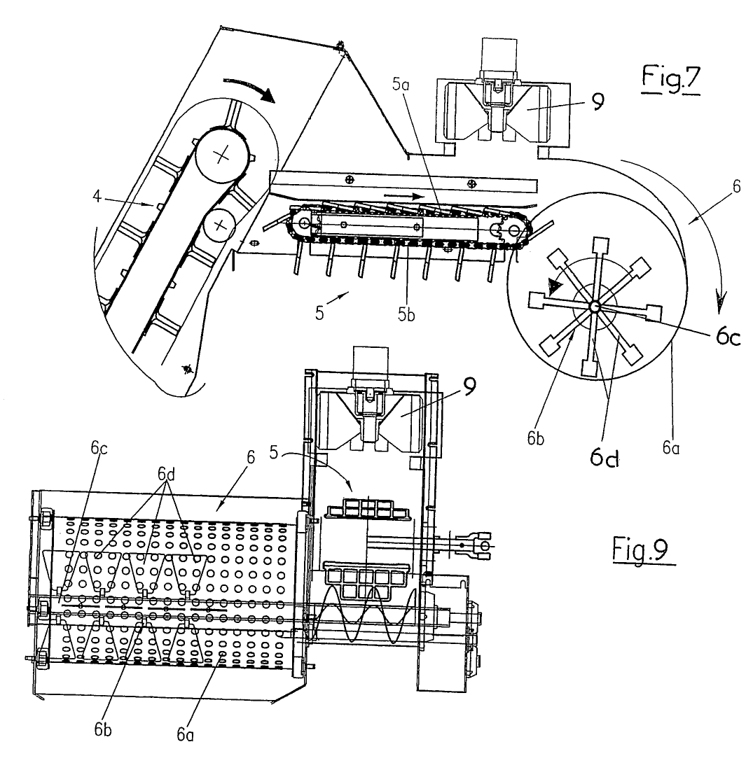

According to a first embodiment of the invention, illustrated in FIGS. 1 through 6, the stripping device or each stripping device comprises, upstream, in the direction of the supply of the rough harvest from the harvest conveyor system 4 to the harvest collection bowl 3, an extractor 5 designed so as to permit extracting the juice and the grapes B detached from the stems by the action of the crop package, and downstream, a stemmer 6 provided with an inlet that communicates with the sloping end of said extractor, said stemmer being designed so as to achieve the hacking of the bunches G forming the remaining part of the harvest and the disposal of the stripped stems and undesirable plant waste, such as leaves, twigs, and various debris.

The extractor 5 can advantageously consist of a conveyor screen executed in the form of an endless belt provided with a mesh and holes sized so as to let through only the juice and grapes detached from the stems, a conveyor screen of that kind and its driving means being described in FR-2,795,599 document.

Two examples of such conveyor screen are described in FR-2,795,599 document, one peculiarity of this conveyor screen 5 being that its leading strand 5a is provided with a small-size mesh that lets through only the juice and grapes detached from the stems and retains the non-picked-off bunches, leaves and stems, while its return strand 5b, provided with openings or a mesh of a larger size than the former, prevents any formation of grape clusters between both strands 5a, 5b of the endless belt.

The stemmer 6 is installed downstream and in the extension of the juice and grape extractor 5.

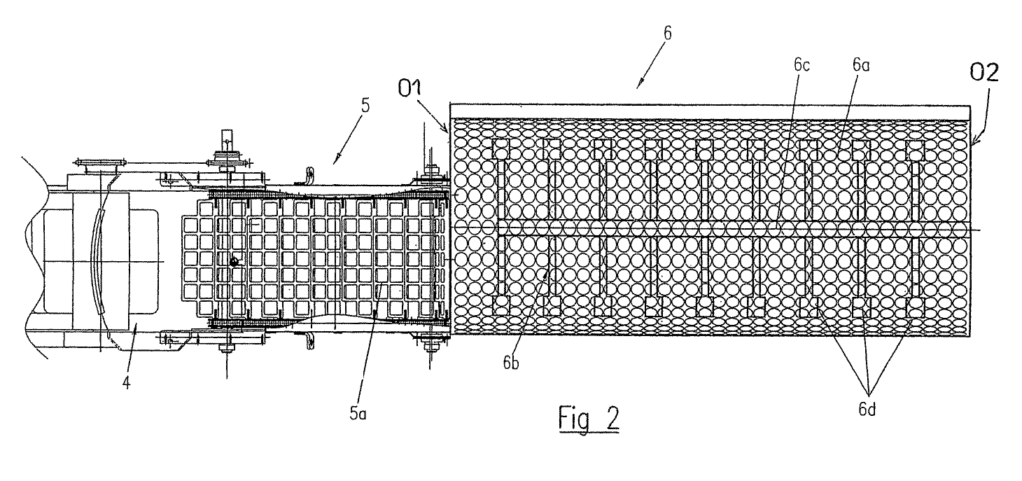

According to the examples shown, the stemmer is of the type comprising a drum 6a with an horizontal or inclined axis, comprising a latticed cylindrical side wall inside which at least one rotating scraper 6b consisting of an axial shaft 6c provided with radial stripping fingers 6d distributed from one end of the shaft to the other, is mounted. A well-known motorization system drives the stripping scraper 6b in a rotary manner in one direction, and drives the perforated drum 6a in a rotary manner in the reverse direction (see arrows on FIG. 3). However, the rotary scraper 6b and the rotating drum 6a could also be driven in a rotary manner in the same direction.

The axis of rotation of the drum 6a can be concentric or not to the axis of the scraper 6b.

The perforations in drum 6a are calibrated so as to let through the grapes. This drum consists, for example, of a stainless steel cylinder provided with a dense grid of perforations or mesh with a circular or square shape. In addition, the successive radial stripping fingers 6d are staggered at an angle of, for example, approx. 30°, along a helical line, so as to feed the harvest residue (stems, plant waste, various debris, small animals, etc . . . ) from the inlet opening O1 of stemmer 6 to the outlet opening O2 of the same.

The juice and grape extractor 5 and the stemmer 6 are arranged one after the other in a horizontal or roughly horizontal position.

It is understood that according to the invention device and method, the juice and the grapes detached from the stems are extracted from the rough harvest discharged by the harvesting conveyor 4 onto the upstream end of the leading strand 5a of the conveyor screen 5, during its transit to the actual stemmer 6 so that said rough harvest is stripped of the juice and grapes forming over one half of the mass of the rough harvest during said transit.

It is thus a much lightened and less bulky harvest, consisting mainly of non-destemmed grapes and containing a certain percentage of plant (and other) waste that is introduced through the downstream end of the conveyor screen 5 into the inlet opening O1 of drum 6a on the actual stemmer 6. The harvest is fed toward the outlet opening O2 of drum 6a with the scraper 6b and stirred by the latter during this transit so that the grapes are detached from the stems under the effect of the reverse motion of the radial stripping fingers 6d and of the drum 6a. The grapes detached from the stems go through the perforations or mesh of the drum side wall and fall by gravity into the underlying collection bowl 3 while the stems, branches, leaves and other waste are discharged through the downstream end of the destemming device that, in the shown example, consists of the drum outlet opening.

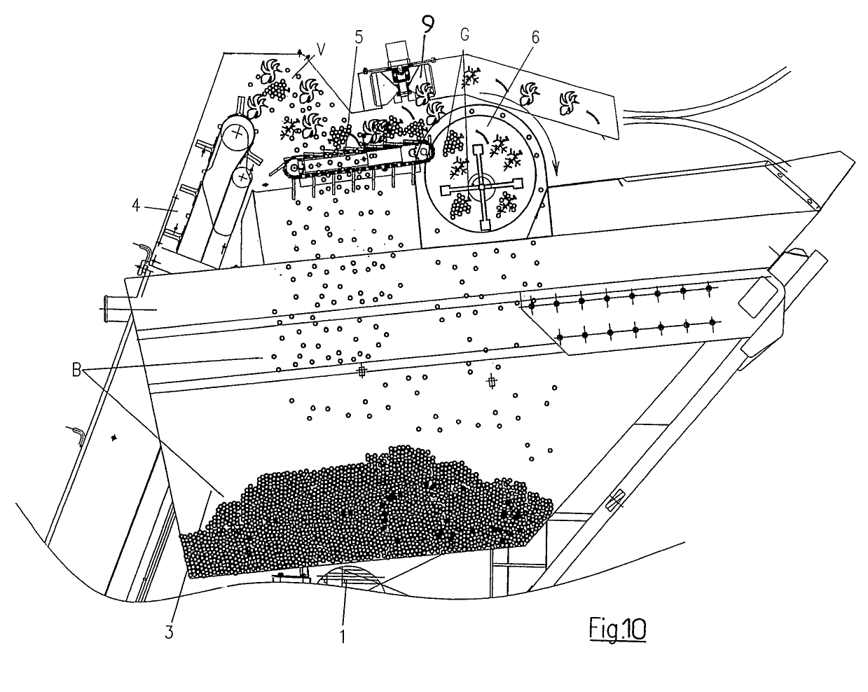

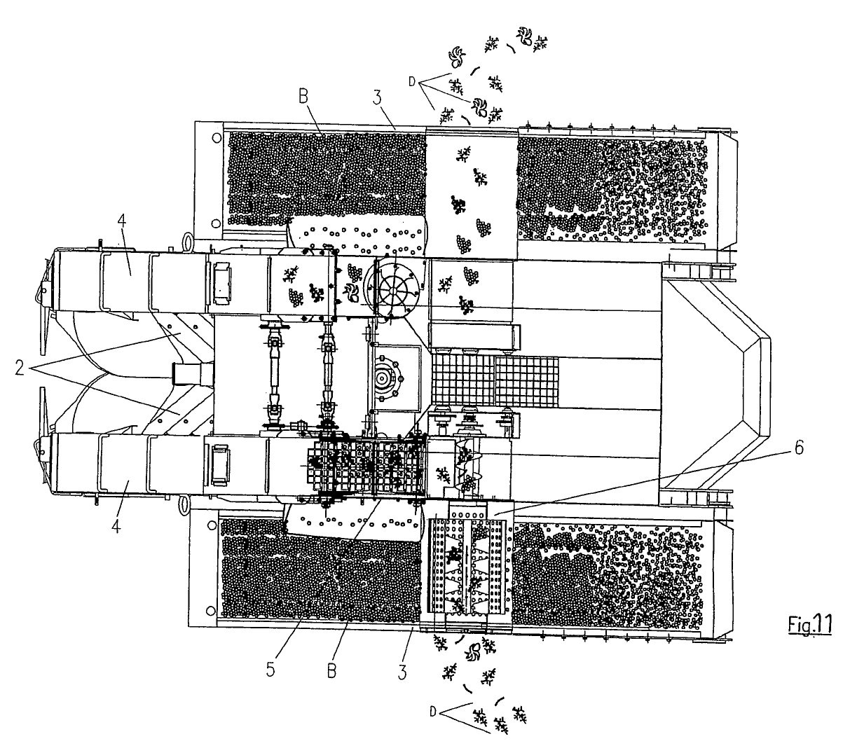

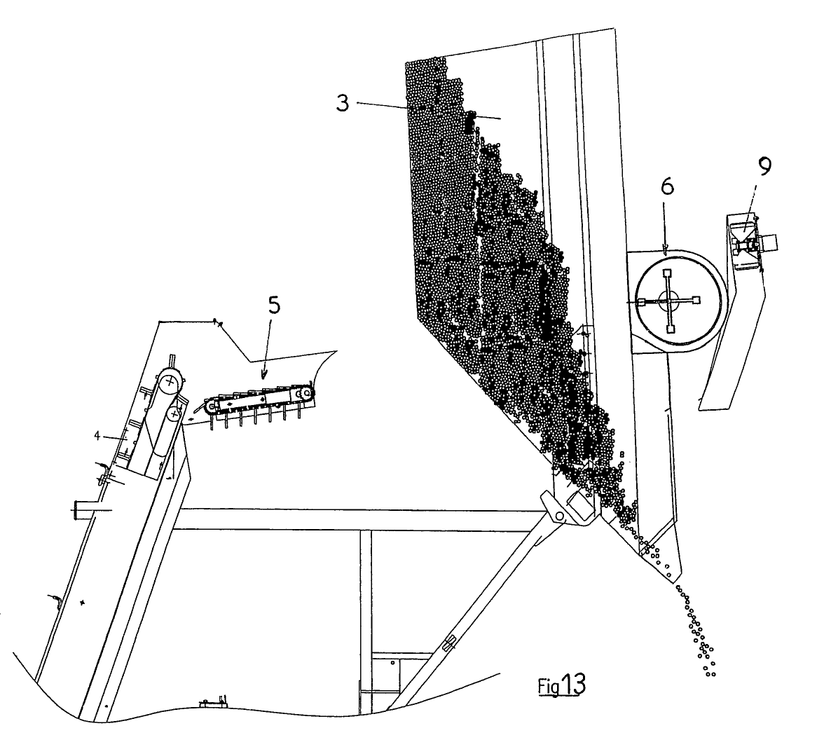

In FIGS. 7 through 13, another preferred embodiment of the invention is represented.

In these figures, the parts of the machine and the components of the destemming system that fulfill functions similar to those of the parts of the machine and the components of the destemming device illustrated in FIGS. 1 through 6 are designated with identical references.

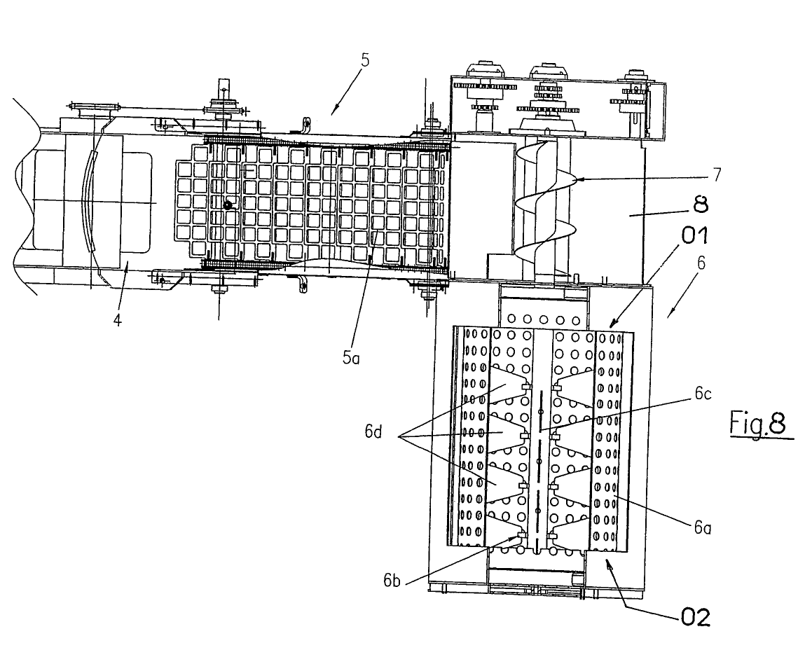

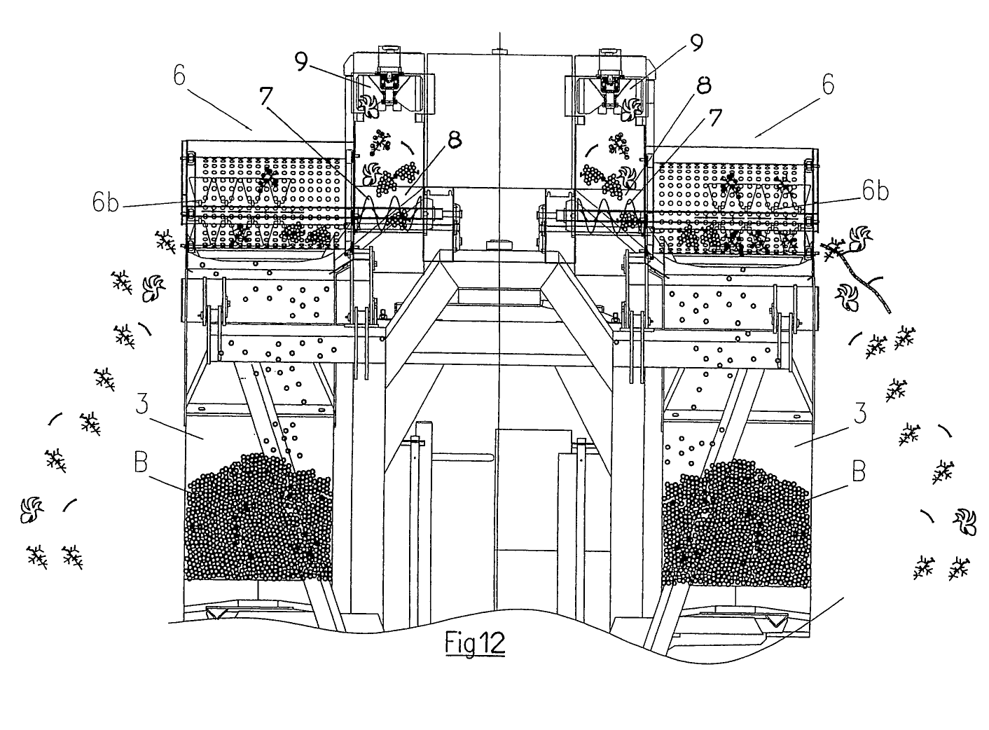

This preferred embodiment differs from the preceding mainly in that the stemmer 6′ and the extractor or sorter 5 of the destemming system or of each destemming system 5-6′ are arranged so as to form an angle between the two of them. Preferably, the stemmer 6′ of the destemming system 5-6′, or of each destemming system is oriented perpendicular or roughly perpendicular to the extractor or sorter 5, as shown in FIGS. 8 and 11. More specifically, the axis of the extractor or of each extractor or sorter 5 is arranged parallel or longitudinally in relation to the moving direction of the machine when working, while the stemmer or each stemmer 6′ is arranged crosswise or perpendicular to said moving direction.

The extractor or sorter 5 and the stemmer 6′ are preferably executed in the manner described above.

A transporting device, consisting for example of a header auger 7 arranged perpendicular to the extractor 5, transports the harvest from said extractor to the stemmer 6′. This header auger is, for example, arranged with a rotating capability at the bottom of trough 8 into which said extractor empties.

Preferably, an aspirator 9 is installed above the extractor or sorter 5. This suction device makes it possible to remove the last waste still present in the harvest before it enters the stemmer 6′.

As indicated above, the harvest entering the stemmer consists solely of grapes on their stems (approx. 20% of the harvest). The juice and grapes detached from the stems and discharged onto the extractor or sorter 5 by the harvest conveyor are fed through said conveyor (approx. 80% of the harvest.)

According to this embodiment, the extractor or sorter 5 is integral with the machine frame while the stemmer 6′ and the aspirator 9 are mounted on the casing of the harvest collection tipping bowls 3, as shown in FIG. 13.

It is understood that the rough harvest V discharged onto the extractors or sorters 5 by the harvest conveyors 4 is relieved of the juice and grapes detached from the stems during its transit on said extractors while the aspirators remove the waste (leaves, petioles, and other plant debris, . . . ) mixed with the bunches. Then, the stems and grapes fully or partially stripped are fed through the stemmer 6 where they are fully deseeded. The grapes B fall into the bowls 3, and the waste of all sorts (petioles, stocks, leaves, stems) are ejected laterally on each side of the machine FIG. 1 1).

I claim:

1. Destemming method applicable to harvesting machines, taking place in succession, when feeding rough harvest between a sloping end of harvest conveyors and harvest collection bowls on said harvesting machines, said method comprising:
extracting of juice and grapes detached from stems by a crop package; and
picking-off of grape bunches not already destemmed that form a remaining part of said rough harvest.

2. Destemming device installed on a harvesting machine between a sloping end of harvest conveyors and harvest collection bowls on said harvesting machine, said destemming device comprising:
an extractor system being located upstream, in a direction of supply of said rough harvest and extracting juice and grapes detached from stems with a crop package; and
a stemmer being located downstream and being provided with an inlet in communication with a sloping end of said extractor system, said stemmer enabling hacking of bunches forming a remaining part of a harvest and rejection of stems and plant and other undesirable waste.

3. Method according to claim 1, wherein said step of extracting juice and grapes detached by the crop package is comprised of using a conveyor screen.

4. Method according to claim 1, wherein said step of picking-off of grape bunches is comprised of using a stemmer with a latticed rotating drum containing a rotary stripping scraper.

5. Method according to claim 4, wherein said stemmer is placed perpendicular to an extractor or sorter of of a destemming system.

6. Method according to claim 5, wherein said extractor and said stemmer are placed one after another in a horizontal or generally horizontal position.

7. Device according to claim 2, wherein said extractor system is comprised of a conveyor screen formed of an endless belt provided with a mesh and holes sized so as let through only the juice and grapes already detached by the crop package.

8. Device according to claim 2, wherein said stemmer has a latticed rotating drum and a rotary stripping scraper housed inside said latticed rotating drum.

9. Device according to claim 8, wherein said latticed drum and the stripping scraper turn in a reverse direction.

10. Device according to claim 2, wherein said extractor system is installed parallel to direction of supply of the machine on which said extractor system is installed, said stemmer being mounted at an angle from said extractor system.

11. Device according to claim 2, wherein said stemmer is placed perpendicular to said extractor system.

12. Device according to claim 10, further comprising:
a transporting means for the harvest from an outlet of said extractor system to an inlet of said stemmer.

13. Device according to claim 12, wherein said transporting means is comprised of a header auger.

14. Device according to claim 2, wherein said extractor system and said stemmer are placed one after another in a horizontal or generally horizontal position.

15. Device according to claim 2, further comprising:
a suction means, being comprised of an aspirator arranged above said extractor system.

16. Harvesting machine comprising:
at least one, and preferably two destemming devices according to claim 2, installed between a sloping end of harvesting conveyors and harvest collection bowls.

17. Harvesting machine according to claim 16, wherein said extractor system is integral with a frame thereof, said stemmer and an aspirator being mounted on a casing of harvest collection tipping bowls.
